(19) United States
(12) Patent Application Publication
(10) Pub. No.: US 2007/0024118 A1
(43) Pub. Date: Feb. 1, 2007

(54) Monolithically integrated power IGBT device

(75) Inventors: Antonino Torres, Catania (IT); Stefano Sueri, Catania (IT); Davide Patti, Catania (IT)

Correspondence Address: JENKENS & GILCHRIST, PC, 1445 ROSS AVENUE, SUITE 3200, DALLAS, TX, 75202, US

(73) Assignee: STMicroelectronics S.r.l., Agrate Brianza (IT)

(21) Appl. No.: 11/438,680

(22) Filed: May 22, 2006

(30) Foreign Application Priority Data
May 24, 2005 (EP) 05425365.3

(51) Int. Cl. B60L 1/00

(52) U.S. Cl. 307/10.1

(57) ABSTRACT

A power IGBT device is monolithically integrated to include an input terminal suitable to receive an input voltage and an output terminal suitable to supply a current having a limited and predetermined highest value. Such IGBT device includes an IGBT power element inserted between said output terminal and a supply reference. The power element has a control terminal connected to the input terminal through a control circuit that includes at least a transistor inserted between the control terminal and the supply reference voltage and a resistive element inserted between the input terminal and the control terminal.

### PRIORITY CLAIM

The present application claims priority from European Patent Application No. 05425365.3 filed May 24, 2005, the disclosure of which is hereby incorporated by reference.

### BACKGROUND OF THE INVENTION

1. Technical Field of the Invention

The present invention relates to a monolithically integrated power IGBT (Insulated Gate Bipolar Transistor) device.

More specifically, the invention relates to a power IGBT device of the type comprising an input terminal suitable to receive an input voltage and an output terminal suitable to supply a current with limited highest value. An IGBT power element is inserted between the output terminal and a GND supply reference and a control terminal is connected to said input terminal by means of a control circuit.

2. Description of Related Art

As it is well known to the skilled in the art, IGBT devices integrated for example by means of Power Mesh SMART-IGBT technology are realized monolithically by means of integration, in a single silicon substrate of a power element, such as an IGBT, and of a control circuit.

Such an IGBT power element is shown for example in FIG. 1 where, in a substrate 1, which, in the example, is of the P+ type, a first layer 1a of the N+ type and a second layer 1b of the N− type have grown epitaxially. In the second layer 1b doped wells of the P+ type are realized to form a body region of the IGBT power element. In the body region of the IGBT power element N+ doped regions are formed to define, in a standard way by means of suitable metalizations, gate or control and emitter terminals of such IGBT power element.

Below the substrate 1, a collector or output terminal of the IGBT power element is also defined.

In power IGBT devices realized with Power Mesh technology for applications wherein it is necessary to limit the highest current in the output terminal, the control circuit associated with the IGBT power element comprises elementary components, properly formed during a standard process suitable to realize the IGBT power element itself. Such process, maintained unaltered, allows power IGBT devices to obtain advantages also as regards their functionality since the different elementary components of the device are realized with uniform technical characteristics.

In particular, the elementary components of the control circuit of a power IGBT device for applications wherein it is necessary to limit the output highest current essentially are: enhancement N-MOS transistors, polysilicon resistors, polysilicon diodes and high voltage JFET transistors.

As it is well known, an enhancement N-MOS transistor is realized by using a lateral diffusion of two P+ doped wells realized on the silicon substrate and suitable to form the body of the IGBT power element. By means of a standard process the gate, source and drain terminals are thus defined.

Moreover, to realize transistors with longer channel lengths, always by means of such technology, it is sufficient to ensure the channel continuity by providing the implantation of a suitable P doped silicon well between two P+ doped wells, as shown in FIG. 2.

In such case, the gate terminal of a transistor with a higher channel is realized by adding a polysilicon stripe which is suitably separated from the body by means of an oxide, whereas, the source and drain terminals are obtained by means of a N+ well diffusion according to the standard process.

Elementary components such as resistances and polysilicon diodes are realized according to the process used to produce IGBT power elements for applications at high voltage, wherein it is necessary to limit the highest collector voltage, by using, for example, a chain of polysilicon back to back diodes connected between collector and gate of the IGBT power element.

To obtain the high voltage JFET elementary component, as shown in FIG. 3, a throttling effect is instead exploited which is present in an area of the N− epitaxial region, closed between two P+ doped wells.

It is to be noted that such elementary components allow to realize simple control circuits for IGBT power elements suitable to obtain IGBT power devices with a limitation in the output highest current.

A possible application of such IGBT power devices is in the systems for electronic ignition where, in fact, driving a coil, present in the system, is required with a limitation of the output current.

An embodiment of a coil driving system with limited output current power IGBT devices, of the known type, is shown in FIG. 4.

In such solution a power IGBT device 1 is highlighted with an input terminal IN connected to an input voltage Vin and an output terminal OUT which supplies a coil 4 of a schematically indicated ignition system 3. The power IGBT device 1 comprises a power IGBT element 2 inserted between the output terminal OUT and a ground reference GND and having a gate terminal G connected to the input voltage Vin by means of the interposition of a control circuit 6. The control circuit 6, inserted between the input voltage Vin and the ground reference GND, comprises a plurality of components, such as MOS transistors and resistors, suitably connected in a known way.

The control circuit 6 feedback receives the current being present on the output terminal OUT through a power Sense-IGBT element 5, placed in parallel to the power IGBT element 2, and it drives the power element 2 limiting its highest output current value.

In particular, the operation of the control circuit 6 provides that an N-MOS transistor, called M3, senses the voltage across a resistance Rsen of the Sense-IGBT element 5, voltage which is proportional to the output current of the power IGBT element 2. The transistor M3 drives an N-MOS transistor, called M4. If the voltage sensed by the transistor M3 increases, the transistor M3 passes from the ohmic region of operation to the saturation and similarly the transistor M4 suitably biases, by means of a resistance Rg, the input of the power IGBT element 2, so that the output current does not exceed a predetermined value.

The main drawback exhibited by power IGBT devices of this type is that of particular voltage oscillations in tension which appear in the output terminal OUT when a current limitation occurs at the output terminal itself. Such oscillations reflect on the secondary winding of the coil 4 causing undesired sparks on the plug connected thereto.

It is suggested, to stabilize the voltage on the output terminal OUT, realizing a control circuit which comprises compensation networks able to introduce a dominant pole, in the transfer function, capable of compensating possible oscillations.

However, in power IGBT devices obtained by means of Power Mesh technology such solution cannot be realized. In fact, in such case, the elementary components which can be realized in the control circuit cannot be compared to the resistances due to the incompatibility existing between the threshold voltage of an N-MOS transistor, typically equal to 2V, and that of the supply voltage Vin, typically equal to 3V. The control circuit does not comprise instead active loads, i.e. components such as for example those of the capacitors which could introduce the dominant pole required in the transfer function.

The approach indicated is made even more difficult due to the absence, in the Power Mesh technology, of processes for the realization of elementary components such as capacitors.

A further drawback the power IGBT device according to the prior art and shown in FIG. 4 exhibits is the poor shielding with respect to the presence of external electromagnetic fields, which causes disturbances invalidating the operation of the device itself.

There is accordingly a need for devising a monolithically integrated power IGBT device having such structural and functional characteristics as to allow to overcome the limitations and drawbacks still affecting the devices realized according to the prior art.

### SUMMARY OF THE INVENTION

In accordance with the present invention a control circuit of a power element of an IGBT device comprises a control circuit configured in such a way as to clamp the input voltage of the power element so as to limit the highest output current of the IGBT device.

In accordance with an embodiment of the invention, a monolithically integrated power IGBT device comprises an input terminal suitable to receive an input voltage and an output terminal suitable to supply a current. A IGBT power element is inserted between said output terminal and a supply reference voltage and having a control terminal. A control circuit couples said input terminal to the control terminal and comprises a first transistor inserted between said control terminal and said supply reference voltage, and a resistive element inserted between said input terminal and said control terminal.

In accordance with another embodiment, a monolithically integrated power IGBT device comprises an IGBT having a collector terminal, an emitter terminal and a control terminal. A first MOS transistor is diode configured with its gate and first conduction terminal coupled to the control terminal of the IGBT. A resistance is coupled between the control terminal of the IGBT and an input voltage.

### BRIEF DESCRIPTION OF THE DRAWINGS

A more complete understanding of the method and apparatus of the present invention may be acquired by reference to the following Detailed Description when taken in conjunction with the accompanying Drawings wherein:

FIGS. 1, 2 and 3 show a section view of a substrate portion comprising respectively a power IGBT device, an increased channel transistor and a JFET transistor realized according to the prior art;

FIG. 4 shows a circuit scheme of a power IGBT device with a control circuit realized according to the prior art;

FIG. 5 shows a circuit scheme of an IGBT device realized according to the present invention;

FIG. 6 shows a further embodiment of the IGBT device realized according to FIG. 5.

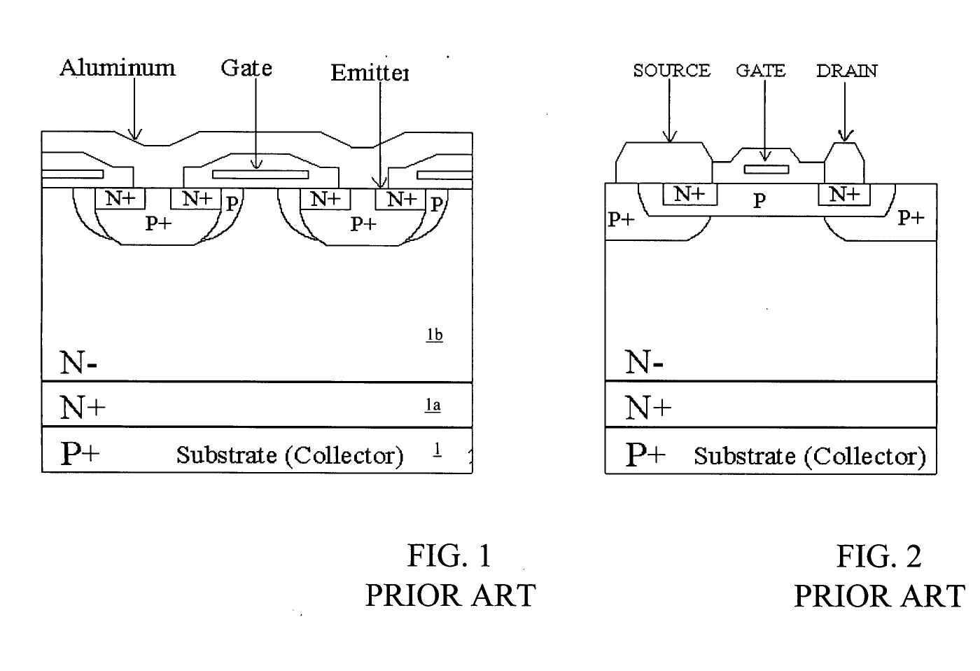

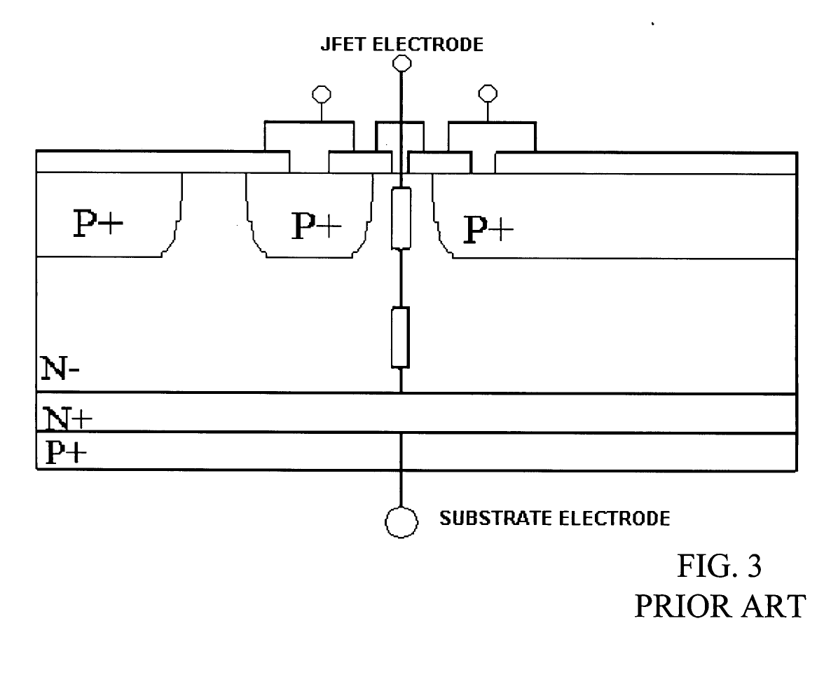

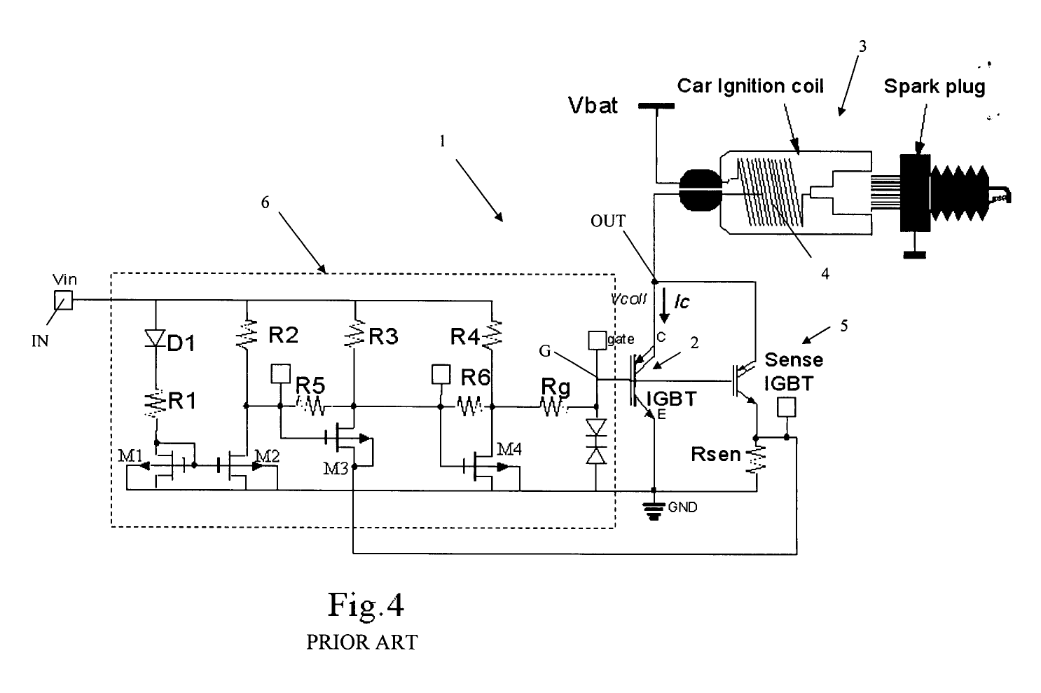

### DETAILED DESCRIPTION OF THE DRAWINGS

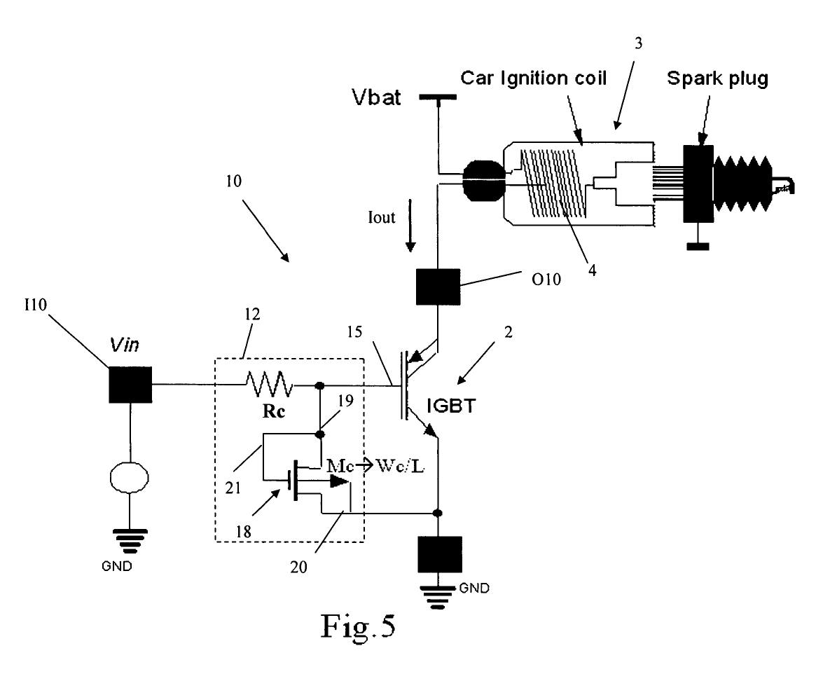

With reference to the annexed figures and in particular to FIG. 5, reference 10 indicates a power IGBT device realized according to the present invention suitable to supply an output terminal O10, coupled to an input to a coil 4 of an ignition device 3, which is shown in a schematic way, with a current Iout having a limited highest value.

The power IGBT device 10 exhibits an input terminal I10 suitable to receive a proper input voltage Vin.

The power IGBT device 10 also comprises a power element 2 inserted between the output terminal O10 and a ground voltage reference GND.

The power element 2 comprises a control terminal 15, in particular a gate terminal connected to the input terminal I10 by means of interposition of a control circuit 12.

Advantageously, according to the present invention, the control circuit 12 comprises a transistor 18, of the MOS type, connected with a first conduction terminal 19 to the control terminal 15 of the power element 2 and with a second conduction terminal 20 to the ground voltage reference GND.

The transistor 18 is suitably diode-connected, i.e. it exhibits a third command or control terminal 21 connected to the first conduction terminal 19 and thus to the control terminal 15 of the power element 2.

Moreover, advantageously, the control circuit 12 exhibits a resistive element Rc inserted between the input terminal I10 and the control terminal 15 of the element 10. Such resistive element Rc can advantageously be a polysilicon resistance as indicated in FIG. 5 or a MOS transistor.

Suitably, the resistance Rc, in the presence of a defined input voltage Vin, allows to bias the transistor 18.

In the present embodiment the transistor 18 is of the enhancement N-MOS type.

As regards the operation, the transistor 18, diode-connected and biased by the resistance Rc, allows to adjust the input voltage of the power element 2, in correspondence with the control terminal 15, allowing to limit, consequently, the highest value of the output current Iout from the output terminal O10, which supplies the coil 4 of the ignition device 3.

Advantageously thus the proposed solution allows to limit the output current Iout of the power element 2 by clamping the voltage at the control terminal 15 by means of a simple control circuit 12 comprising a transistor 18 being diode-connected and biased by a resistance Rc.

The power element 2 and the transistor 18 are monolithically integrated, during the same process, i.e. by means of Power Mesh “Smart-Igbt” technique, thus, there exists a certain correlation between their physical characteristics. In particular, it comes that the MOS transistor 18 exhibits a threshold voltage which is correlated with the threshold voltage of the power element 2 since both exhibit, obviously, a same polysilicon structure of the control terminals 15 and of the command terminal 21.

In particular, moreover, according to the dimensions of the power element 2, it is possible to change the value of the voltage at the control terminal 15, the highest current value Iout thus being adjustable at the output terminal O10.

The present solution can be subjected to several versions all within the same scope of protection.

In particular, it is possible to realize, as further embodiment, a monolithically integrated power IGBT device 10 with the value of the highest output current Iout being adjustable.

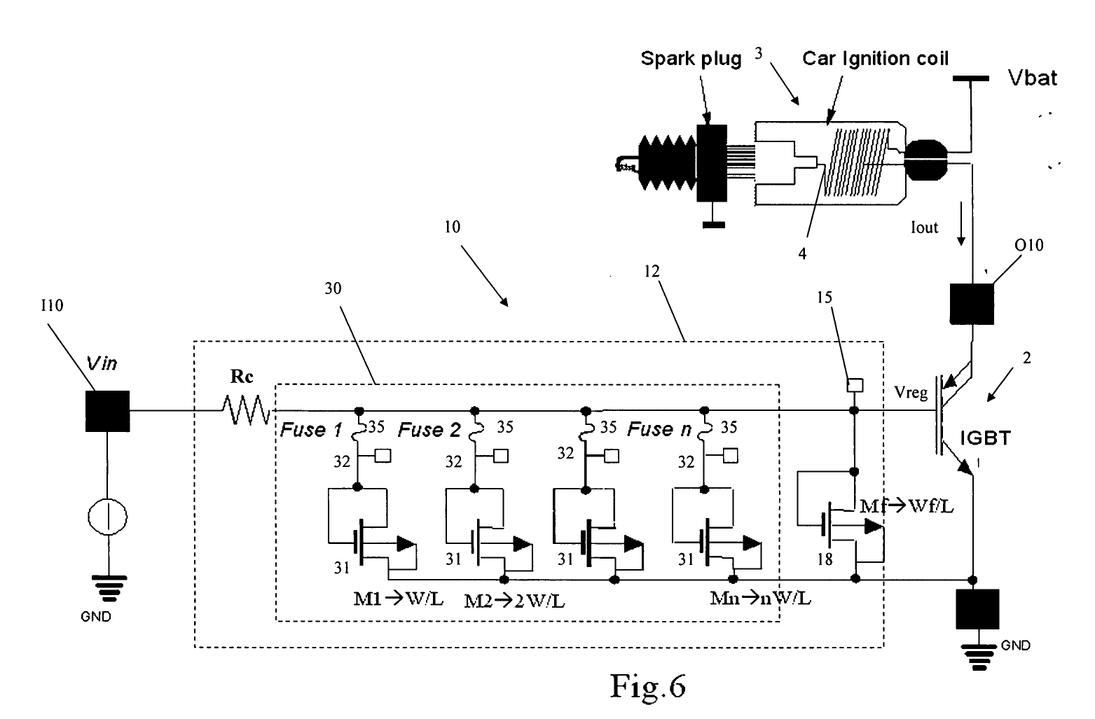

A preferred embodiment of this version is shown in FIG. 6, and, in the following description, the same numbers previously used to indicate structurally and functionally similar components will be maintained.

The power IGBT device 10 is connected by means of an output terminal O10 to a coil 4 of an ignition device 5 and by means of an input terminal I10 to a suitable input voltage Vin.

The device 10 comprises a power element 2 inserted between the output terminal O10 and a ground voltage reference GND and it exhibits a control terminal 15 connected to the input terminal I10 by means of the interposition of a control circuit 12.

Advantageously, according to the present invention, the control circuit 12 comprises a transistor 18, of the MOS type, connected between the control terminal 15 of the power element 10 and the ground voltage reference GND.

The transistor 18 is suitably diode-connected and it is suitably biased, to the input voltage Vin, by means of a resistance Rc connected between the input terminal I10 and the control terminal 15 of the power element 2.

Advantageously, moreover, according to the present embodiment, the control circuit 12 comprises a modular element 30 which allows to adjust a voltage Vreg to the control terminal 15 of the power element 10.

Suitably, the modular element 30 is inserted between said control terminal 15 and said ground reference GND and it comprises n transistors 31 (wherein n may represent a plurality of transistors), conveniently diode-connected, arranged in parallel to each other and in parallel to the transistor 18.

Advantageously, each of the n transistors 31 comprises an output terminal 32 connected to the control terminal 15 by means of an enable fuse 35. The fuses 35, suitably programmed, allow to enable or disable the corresponding transistors 31.

Conveniently, moreover, the n transistors 31 of the modular element 30 exhibit a structure with a channel length L being identical to each other but with a multiple width W, advantageously according to a binary weight, obtaining, considering the transistor 18 and the n transistors 31, a global width WC equal to:
Wc=Wf+W+2W+ . . . +nW
where Wf indicates the channel width of the transistor 18, while W, 2W, . . . nW respectively indicate the channel widths of the n transistors 31 defining the modular element 30.

When all the fuses enable the n transistors 31 the global channel width is Wc, whereas such value is reduced when the fuses suitably disable some of the n transistors 31. In the case wherein the whole modular element 30 is disabled the global channel Wc is equal to Wf i.e. simply the channel width of the transistor 18.

Thus, by indicating as Vf the voltage across the transistor 18 of dimensions Wf/L and as Vc the voltage across a transistor equivalent to the transistor 18 in parallel to the modular element 30 of dimensions Wc/L it is possible to modulate the voltage Vreg applied to the control terminal 15 of the transistor 18 with a step equal to (2n−1) where n is the number of the transistors 31.

In other words, the proposed solution allows to vary the voltage Vreg at the control terminal 15 in values comprised between Vc and Vf according to how many of the n transistors 31 of the modular element 30 are enabled, in a scale of (2n−1) possible values.

A main advantage of the power IGBT device realized according to the present invention is that of exhibiting a control circuit which comprises a reduced number of elementary components and which allows to limit the output current by clamping the voltage onto the control terminal of the power element, stabilizing in the meantime the current at the output terminal.

Another advantage is the improved dynamic behavior of the power IGBT device realized according to the present invention linked to the fact that the control circuit, not exhibiting amplifier stages, allows to limit the output current avoiding oscillations on the collector voltage.

A further advantage of the present invention is that of being able to adjust, in a proportional way, according to the number of the transistors defining the modular element, the voltage at the control terminal of the power element and thus define similar modular values of the highest current present at the output terminal. This obviously allows to remarkably amplify the field of use of a single power IGBT device thus realized.

Another advantage of the present invention is the high immunity the device exhibits linked to the fact that the control circuit realized with the elementary components, such as resistors and transistors, is more shielded against the disturbances coming from external electromagnetic fields, not needing, moreover, any compensation network.

Moreover, the present invention realizes a monolithically integrated power IGBT device which allows to correlate the electrical characteristics of all the components optimizing the performances during the dynamic operation and allowing, in the meantime, an improved adaptation to the application.

Although preferred embodiments of the device of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A monolithically integrated power IGBT device, comprising:
an input terminal suitable to receive an input voltage;
an output terminal suitable to supply a current;
an IGBT power element inserted between said output terminal and a supply reference voltage and having a control terminal;
a control circuit coupling said input terminal to the control terminal comprising:
a first transistor inserted between said control terminal and said supply reference voltage; and
a resistive element inserted between said input terminal and said control terminal.

2. The IGBT device according to claim 1 wherein said first transistor is diode-configured.

3. The IGBT device according to claim 1 wherein said first transistor is a transistor of the enhancement N-MOS type.

4. The IGBT device according to claim 1 wherein said resistive element is one of a polysilicon resistance or a MOS transistor.

5. The IGBT device according to claim 1 wherein said first transistor is biased by said resistive element comprising a resistance.

6. The IGBT device according to claim 1 wherein said control circuit further comprises a modular element inserted between said control terminal and said supply reference voltage.

7. The IGBT device according to claim 6 wherein said modular element comprises: a plurality of second transistors being diode-connected and arranged in parallel to one another and in parallel to said first transistor.

8. The IGBT device according to claim 7 wherein each of said second transistors of said modular element comprises an output terminal connected to said control terminal by an enable fuse.

9. The IGBT device according to claim 8 wherein said second transistors of said modular element exhibit a structure with a channel length being identical to each other and a multiple width according to a binary weight.

10. The IGBT device according to claim 9 wherein said first transistor and said second transistors exhibit channels comprising an identical length and together have a global width Wc equal to:
Wc=Wf+W+2W+ . . . +nW
where:
Wf is a width of the channel of said first transistor;
W, 2W, . . . nW are the widths of the channels of said second transistors; and
n is the number of said transistors.

11. The IGBT device according to claim 10 wherein a Vreg voltage applied to the control terminal is modulated with a step equal to (2n−1), where n is the number of said second transistors.

12. A monolithically integrated power IGBT device, comprising:
an IGBT having a collector terminal, an emitter terminal and a control terminal;
a first MOS transistor diode configured with its gate and first conduction terminal coupled to the control terminal of the IGBT; and
a resistance coupled between the control terminal of the IGBT and an input voltage.

13. The device of claim 12 further comprising:
a fuse element having a first and second end, the first end being coupled to the control terminal of the IGBT; and
a second MOS transistor diode configured with its gate and first conduction terminal coupled to the second end of the fuse element.

14. The device of claim 12 further comprising:
a plurality of fuse elements each having a first and second end, the first ends being coupled to the control terminal of the IGBT; and
a corresponding plurality of second MOS transistors each being diode configured with its gate and first conduction terminal coupled to the second end of one of the fuse elements.

15. The device of claim 14 wherein each of the first and second MOS transistors have a same channel length, and wherein the second MOS transistors have different channel widths.

16. The device of claim 12 wherein said first MOS transistor is a transistor of the enhancement N-MOS type.

17. The device of claim 12 wherein said resistance is provided by a polysilicon resistor.

18. The device of claim 12 wherein said resistance is provided by an MOS transistor.

19. The device of claim 12 wherein a second conduction terminal is first MOS transistor is coupled to a reference voltage.

20. The device of claim 12 further comprising:
a plurality of fuse elements each having a first and second end, the first ends being coupled to the control terminal of the IGBT; and
a corresponding plurality of second MOS transistors each being diode configured with its gate and first conduction terminal coupled to the second end of one of the fuse elements;
wherein the second MOS transistors exhibit a structure having identical channel lengths to each other and differing channel widths set according to a binary weight.
